(19) United States
(12) Patent Application Publication
(10) Pub. No.: US 2014/0061091 A1
(43) Pub. Date: Mar. 6, 2014

(54) COVER TAPE, COMPONENT PACKAGE, AND METHOD OF MAKING THE SAME

(71) Applicants: Weixiang Zhang, Shanghai (CN); Linlin Zhang, Shanghai (CN); Zhou Jin, Shanghai (CN)

(72) Inventors: Weixiang Zhang, Shanghai (CN); Linlin Zhang, Shanghai (CN); Zhou Jin, Shanghai (CN)

(73) Assignee: 3M INNOVATIVE PROPERTIES COMPANY, St. Paul, MN (US)

(21) Appl. No.: 14/002,478

(22) PCT Filed: Mar. 4, 2011
(86) PCT No.: PCT/CN2011/071520

§ 371 Date: Nov. 8, 2013

(51) Int. Cl. B65D 85/00; C09J 7/02; H05F 3/00

(52) U.S. Cl. CPC B65D 85/70; H05F 3/00; C09J 7/0203
USPC 206/714; 428/189; 156/299; 156/272.6

(57) ABSTRACT

A cover tape includes a polymer film substrate having first and second opposed major surfaces. A primer layer is disposed on the first major surface of the polymer film substrate. A static control layer is disposed on the primer layer, the static control layer comprising carbon nanotubes dispersed in a dielectric polymeric binder, wherein the static control layer has a thickness of from 0.1 to 2 microns. Adhesive strips are disposed on the static control layer adjacent opposite edges of the static control layer. Methods of making cover tapes according to the present disclosure, and component packages including them, are also disclosed.

### TECHNICAL FIELD

The present disclosure relates broadly to tapes, packages, and methods for making the same.

### BACKGROUND

In the industry of electronic component packaging, the component is generally produced by one manufacturer and then sent to another manufacturer or user for further processing. Examples of electronic components transferred in this manner include memory chips, integrated circuit chips, resistors, connectors, transistors, processors, capacitors, and gate arrays, and dual in-line packages (DIPs). The packaging method used to transport the electronic components is known as tape-and-reel component packaging. Component packages manufactured using this method include a carrier tape with pocket cavities containing individual electronic components, and a cover tape adhered to the carrier tape and enclosing the pocket cavities. Once transferred to an assembly facility, the cover tape is peeled back from the carrier tape, and the electronic component is removed and mounted on a circuit substrate.

For convenience in handling, the cover tape should generally be easily removed from the carrier tape. However, if the peel force is too low, the component package could delaminate in the transportation and storage. On the other hand, if the peel force is too strong or the variation of the peel force is too big, it will be hard to smoothly remove the cover tape and the enclosed electronic component may be forcibly ejected from the pocket onto an unclean surface such as a factory floor.

Static discharge can ruin electronic components, and it is important that the tape package has sufficient static dissipation properties. Transparency of the cover tape is also important, in order to check the type and condition status of the electronic component without opening the component package. Also, the cover tape should not physically contaminate the electronic components, for example by adhesive transfer.

### SUMMARY

In one aspect, the present disclosure provides a cover tape comprising:
a polymer film substrate having first and second opposed major surfaces;
a primer layer disposed on the first major surface of the polymer film substrate;
a static control layer disposed on the primer layer, the static control layer comprising carbon nanotubes dispersed in a dielectric polymeric binder, wherein the static control layer has a thickness of from 0.1 to 2 microns; and
adhesive strips disposed on the static control layer adjacent opposite edges of the static control layer.

In another aspect, the present disclosure provides a component package comprising:
a carrier tape comprising a film body having at least one pocket recess therein;
at least one electronic component disposed within the at least one pocket recess; and
a cover tape releasably adhered to the carrier tape such that the at least one pocket recess is substantially sealed, wherein the cover tape comprises:
a polymer film substrate having first and second opposed major surfaces;
a primer layer disposed on the first major surface of the polymer film substrate;
a static control layer disposed on the primer layer, the static control layer comprising carbon nanotubes dispersed in a dielectric polymeric binder, wherein the static control layer has a thickness of from 0.1 to 2 microns; and
adhesive strips disposed on the static control layer adjacent opposite edges of the static control layer, wherein the adhesive strips contact the carrier tape.

In yet another aspect, the present disclosure provides a method of making a cover tape, the method comprising:
providing a polymer film substrate having first and second opposed major surfaces;
applying a primer layer onto the first major surface of the polymer film substrate;
applying a static control layer onto the primer layer, the static control layer comprising carbon nanotubes dispersed in a dielectric polymeric binder, wherein the static control layer has a thickness of from 0.1 to 2 microns; and
disposing adhesive strips on the static control layer adjacent opposite edges of the static control layer.

Advantageously, cover tapes according to the present disclosure have good clarity, transparency, and appearance, are relatively easy to manufacture, and exhibit consistent and long-lasting static control.

The features and advantages of the present disclosure will be further understood upon consideration of the detailed description as well as the appended claims.

### BRIEF DESCRIPTION OF THE DRAWINGS

FIG. 1 is a schematic cross-sectional view of an exemplary cover tape 100 according to the present disclosure; and

FIG. 2 is a perspective schematic view of an exemplary component package 200 according to the present disclosure.

While the above-identified drawing figures set forth several embodiments of the present disclosure, other embodiments are also contemplated, as noted in the discussion. In all cases, this disclosure presents the disclosure by way of representation and not limitation. It should be understood that numerous other modifications and embodiments can be devised by those skilled in the art, which fall within the scope and spirit of the principles of the disclosure. The figures may not be drawn to scale.

### DETAILED DESCRIPTION

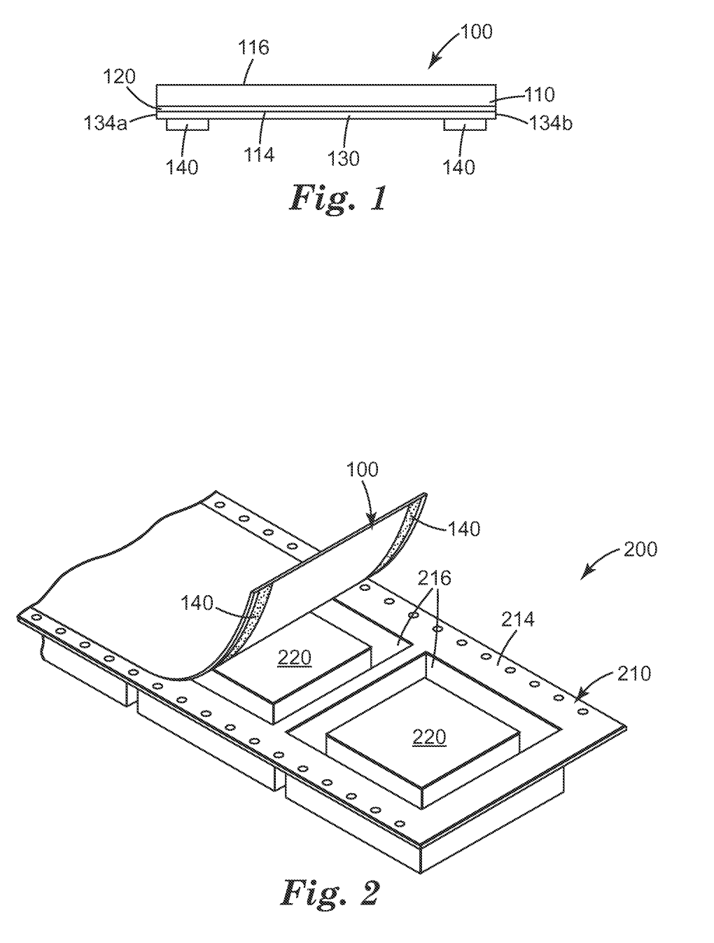

Referring now to FIG. 1, cover tape 100 comprises polymer film substrate 110, which has first and second opposed major surfaces (114, 116), respectively. Primer layer 120 is disposed on first major surface 114. Static control layer 130 is disposed on primer layer 120. Adhesive strips 140 are disposed on static control layer 130 adjacent opposite edges (134a, 134b) of static control layer 130.

Static control layer 130 comprises carbon nanotubes dispersed in a dielectric polymeric binder. The carbon nanotubes may be single-walled or multiple-walled. Carbon nanotubes are readily available from commercial sources. Examples of suitable carbon nanotubes include those multi-wall carbon nanotubes available as AQUACYL AQ0101 multi-wall carbon nanotube dispersion from Nanocyl S.A. (Sambreville, Belgium). The carbon nanotubes are typically present in the static control layer in an amount of from 0.5 to 5 percent (for example, in a range of from 1 to 3 percent) based on a total weight of the static control layer, however lesser and greater amounts may also be used.

Suitable dielectric polymeric binders include, for example, non-conducting acrylic polymers, polyurethanes, polyvinyl chloride plastisols, and ethylene vinyl acetate copolymers. In some embodiments, the dielectric polymeric binder is formed by coalescing, and optionally thermosetting, a corresponding latex dispersion (for example, an aqueous dispersion of corresponding polymeric binder particles). This method may be particularly advantageous if using dispersions of the carbon nanotubes that include a dispersing medium that is compatible with the liquid phase of the polymer latex dispersion.

The static control layer 130 has a thickness of from 0.1 micron to 2 microns. In some embodiments, the static control layer has a thickness in a range of from 0.1 micron to 1 micron, or even from 0.1 to 0.5 micron. The surface resistivity of the static control layer is generally in a range of from 10⁵ ohms per square to 10¹⁰ ohms per square, although lower surface resistivity is also suitable.

The polymer film substrate may comprise, for example, any organic polymer, and have any thickness as long as it is self-supporting. Typically, the polymer film substrate is flexible or semi-rigid to facilitate handling, although this is not a requirement. For example, in some embodiments the polymer film substrate may have a thickness in a range from 10 to 60 microns. Generally, if the polymer film substrate is too thin, web handling problems may occur manufacture of the cover tape, while if the thickness of base film is excessively thick, then the cost to manufacture will be unnecessarily raised.

Exemplary suitable polymers include polyolefins (for example, polypropylene, polyethylene, and oriented versions thereof), polyamides, cellulosic ester polymers, and polyesters. In some embodiments, the polymer film substrate comprises biaxially oriented polypropylene film.

Depending on the polymer film substrate selected, it may be desirable to modify at least one major surface in order to improve adhesion to the primer layer. This may be accomplished, for example, through a corona discharge treatment, plasma discharge treatment, electron beam treatment, photochemical treatment, flame treatment, or other surface modification technique. In some embodiments (for example, corona treatment of biaxially oriented polypropylene) may result in a surface wetting tension of at least 36 dynes/cm, which may facilitate adhesion between the primer and the polymer film substrate.

The primer layer can include an organic material, reactive or non-reactive, that adheres to the polymer film substrate and the static control layer. Examples of suitable primer compositions include acrylic polymers such as, for example, polyacrylamides, and an aminated acrylic polymer (50 percent solids content available from Nippon Shokubai Co., Ltd. (Osaka, Japan); and polyurethanes such as, for example, NK350, a polyurethane-based primer coating solution available from Nippon Shokubai Co. (Osaka, Japan); ethylene vinyl acetate (EVA) polymers; and copolymers of styrene- ethylene/butylene-styrene.

The adhesive strips adhere the cover tape to the carrier tape. In general, there are positioned adjacent opposite edges of the cover tape, and are positioned such that direct contact with electronic components in the component package is not possible. Examples of suitable adhesives include pressure-sensitive adhesives (which may be repositionable or not), solvent-borne adhesives, reactive adhesives, and hot-melt adhesives. Examples of suitable pressure-sensitive adhesives include pressure-sensitive adhesives made from acrylics, natural latexes, styrene-butadiene rubbers, and reclaimed rubbers. Examples of suitable hot-melt adhesives include: polyamides, polyolefins, styrene-butadiene block copolymers, and ethylene-vinyl acetate copolymers. In some embodiments, the adhesive is selected from the group consisting of a pressure-sensitive adhesive, a heat-activated adhesive, or a combination thereof.

The adhesive strips may be applied to the cover tape or the carrier tape by any suitable method including, for example, contact printing, spraying, or other strip coating techniques. The adhesive strips may also be applied using double-sided adhesive transfer tape.

Optionally, the cover tape may have longitudinally-oriented perforations and/or score lines to facilitate access to the electronic components contained in the component package; however, this is not a requirement.

Cover tapes according to the present disclosure may be substantially transparent. For example, if measured along a line normal to the second major surface of the polymeric film substrate they may have a light transmittance of at least 80, 85, or even 90 or more using a D65 standard illuminant.

Cover tapes according to the present disclosure can be made, for example according to the following method. First, first major surface of a polymer film substrate having first and second opposed major surfaces is optionally modified by a treatment such as, for example, corona discharge to raise its surface energy. Next a primer layer is applied to the optionally surface-treated first major surface. The primer layer may be applied using conventional techniques such as for example, flood coating, spraying, bar coating, slot coating, die coating, and gravure coating, followed by drying (for example, in an oven or by other heating means). The static control layer is applied to the primer layer, for example, using techniques as described for application of the primer layer, above. The adhesive strips are then applied to the static control layer adjacent opposite edges of the static control layer.

Cover tapes according to the present disclosure are useful in tape-and-reel component packaging.

Referring now to FIG. 2, component package 200 includes carrier tape 210 adhered to and cover tape 100 by adhesive strips 140, which contact cover tape 100 and carrier tape 210. Carrier tape 210 comprises a film body 214 having pocket recesses 216 therein. Electronic components 220 are disposed within pocket recesses 216. Cover tape 100 according to the present disclosure releasably adhered to carrier tape 210 such that pocket recesses 216 are substantially sealed.

The carrier tape may be formed of any suitable self-supporting material, which may be flexible and optionally thermoformable. Examples of suitable materials include thermoplastic polymers such as, for example, polyesters, polyamides, polycarbonates, cellulosic polymers, and combinations thereof.

Optionally the component package may have sprocket holes or other indexing perforations or markings (for example, along opposite edges of the component package); which may facilitate automated handling.

Component packages according to the present disclosure may be made, for example, by laminating a cover tape according to the present disclosure with the carrier tape such that at least some of the pocket recesses in the carrier tape are substantially sealed.

### Select Embodiments of the Present Disclosure

In a first embodiment, the present disclosure provides a cover tape comprising:
a polymer film substrate having first and second opposed major surfaces;
a primer layer disposed on the first major surface of the polymer film substrate;
a static control layer disposed on the primer layer, the static control layer comprising carbon nanotubes dispersed in a dielectric polymeric binder, wherein the static control layer has a thickness of from 0.1 to 2 microns; and
adhesive strips disposed on the static control layer adjacent opposite edges of the static control layer.

In a second embodiment, the present disclosure provides a cover tape according to the first embodiment, wherein the dielectric polymeric binder comprises at least one of a polyurethane or an acrylic polymer.

In a third embodiment, the present disclosure provides a cover tape according to the first or second embodiment, wherein the carbon nanotubes are present in the static control layer in an amount of from 1 to 3 percent by weight based on a total weight of the static control layer.

In a fourth embodiment, the present disclosure provides a cover tape according to any one of the first to third embodiments, wherein the static control layer has a thickness in a range of from 0.1 to 0.5 microns.

In a fifth embodiment, the present disclosure provides a cover tape according to any one of the first to fourth embodiments, wherein the adhesive is selected from the group consisting of a pressure-sensitive adhesive, a heat-activated adhesive, or a combination thereof.

In a sixth embodiment, the present disclosure provides a cover tape according to any one of the first to fifth embodiments, wherein the polymer film substrate comprises biaxially-oriented polypropylene.

In a seventh embodiment, the present disclosure provides a cover tape according to any one of the first to sixth embodiments, wherein the first major surface of the polymer film substrate is corona-treated.

In an eighth embodiment, the present disclosure provides a component package comprising:
a carrier tape comprising a film body having at least one pocket recess therein;
at least one electronic component disposed within the at least one pocket recess; and
a cover tape releasably adhered to the carrier tape such that the at least one pocket recess is substantially sealed, wherein the cover tape comprises:
a polymer film substrate having first and second opposed major surfaces;
a primer layer disposed on the first major surface of the polymer film substrate;
a static control layer disposed on the primer layer, the static control layer comprising carbon nanotubes dispersed in a dielectric polymeric binder, wherein the static control layer has a thickness of from 0.1 to 2 microns; and
adhesive strips disposed on the static control layer adjacent opposite edges of the static control layer, wherein the adhesive strips contact the carrier tape.

In a ninth embodiment, the present disclosure provides a component package according to the eighth embodiment, wherein the dielectric polymeric binder comprises at least one of a polyurethane or an acrylic polymer.

In a tenth embodiment, the present disclosure provides a component package according to the eighth or ninth embodiment, wherein the carbon nanotubes are present in the static control layer in an amount of from 1 to 3 percent by weight based on a total weight of the static control layer.

In an eleventh embodiment, the present disclosure provides a component package according to any one of the eighth to tenth embodiments, wherein the static control layer has a thickness in a range of from 0.1 to 0.5 microns.

In a twelfth embodiment, the present disclosure provides a component package according to any one of the eighth to eleventh embodiments, wherein the adhesive is selected from the group consisting of a pressure-sensitive adhesive, a heat-activated adhesive, or a combination thereof.

In a thirteenth embodiment, the present disclosure provides a component package according to any one of the eighth to twelfth embodiments, wherein the polymer film substrate comprises biaxially-oriented polypropylene.

In a fourteenth embodiment, the present disclosure provides a component package according to any one of the eighth to thirteenth embodiments, wherein the first major surface of the polymer film substrate is corona-treated.

In a fifteenth embodiment, the present disclosure provides a method of making a cover tape, the method comprising:
providing a polymer film substrate having first and second opposed major surfaces;
applying a primer layer onto the first major surface of the polymer film substrate;
applying a static control layer onto the primer layer, the static control layer comprising carbon nanotubes dispersed in a dielectric polymeric binder, wherein the static control layer has a thickness of from 0.1 to 2 microns; and
disposing adhesive strips on the static control layer adjacent opposite edges of the static control layer.

In a sixteenth embodiment, the present disclosure provides a method of making a cover tape according to the twelfth embodiment, wherein the dielectric polymeric binder comprises at least one of a polyurethane or an acrylic polymer.

In a seventeenth embodiment, the present disclosure provides a method of making a cover tape according to the fifteenth or sixteenth embodiment, wherein the carbon nanotubes are present in the static control layer in an amount of from 1 to 3 percent by weight based on a total weight of the static control layer.

In an eighteenth embodiment, the present disclosure provides a method of making a cover tape according to any one of the fifteenth to tenth embodiments, wherein the static control layer has a thickness in a range of from 0.1 to 0.5 microns.

In a nineteenth embodiment, the present disclosure provides a method of making a cover tape according to any one of the fifteenth to eighteenth embodiments, wherein the adhesive is selected from the group consisting of a pressure-sensitive adhesive, a heat-activated adhesive, or a combination thereof.

In a twentieth embodiment, the present disclosure provides a method of making a cover tape according to any one of the fifteenth to nineteenth embodiments, wherein the polymer film substrate comprises biaxially-oriented polypropylene.

In a twenty-first embodiment, the present disclosure provides a method of making a cover tape according to any one of the fifteenth to twentieth embodiments, further comprising corona treating the first major surface of the polymer film substrate.

Objects and advantages of this disclosure are further illustrated by the following non-limiting examples, but the particular materials and amounts thereof recited in these examples, as well as other conditions and details, should not be construed to unduly limit this disclosure.

### EXAMPLES

Unless otherwise noted, all parts, percentages, ratios, etc. in the Examples and the rest of the specification are by weight.

Light transmittance was determined using an HM-150 haze meter from Murakami Color research Laboratory (Tokyo, Japan) according to ASTM D1003-07e1 “Standard Test Method for Haze and Luminous Transmittance of Transparent Plastics.”Surface resistivity was measured using a Trek Model 152resistance meter from Trek Japan (Tokyo, Japan) placed in contact with the surface of an article to be measured using an applied pressure of about 5 pounds (2.3 kg) and a voltage of 10 V or 100 V.

Surface durability was measured by using a model 5130 Taber Abraser rotary platform abraser from Taber Industries of Buffalo, N.Y., equipped with a CS-5 grinding wheel. A specimen was considered durable as long as its surface resistivity was less than or equal to 1×10¹² ohms/square.

### Example 1

A roll of biaxially-oriented polypropylene (BOPP) film with 50 microns thickness was corona-treated on one side of the film resulting in a surface having a wetting tension greater than 38 dynes/cm (determined using a dyne pen available as ACCU DYNE TEST from Diversified Enterprises (Claremont, N.H.). A solvent mixture was prepared by combining 11000 g of deionized water, 3036 g of N-methylpyrrolidone, and 330 g of triethylamine. Then, 1000 parts of a one percent by weight carbon nanotube (CNT) dispersion, obtained as AQUACYL AQ0101 carbon nanotube dispersion from Nanocyl S.A. (Sambreville, Belgium), was added to 2450 parts of a 20 percent by weight polyurethane (PU) emulsion obtained as R-986 from DSM N.V. (Heerlen, The Netherlands), and then stirred for 10 minutes, followed by addition with stirring of 13217 parts of the solvent mixture prepared above. The resultant coating mixture (SOLUTION A) was stirred for 5 minutes.

A primer coating (NK350, a polyurethane-based primer coating solution from Nippon Shokubai Co. (Osaka, Japan)) was gravure roll-coated onto the corona-treated side of the BOPP film, and dried, resulting in a dry coating thickness of 0.3 microns. The primer-coated film was heated in an oven at 100° C. for 12 seconds.

Next, SOLUTION A was coated onto the primer layer of the primer-coated film prepared above using a gravure roll (150 lines per inch). The resultant coated film was then heated in an oven at 100˜120° C. for about 30 seconds to dry the wet coating thereby providing a static control layer, then wound into a roll. The resulting roll was strip-coated onto the static control layer along opposite edges using adhesive available as 34-197B rubber-based hot-melt pressure-sensitive adhesive, from National Starch and Chemical Co. of Bridgewater, N.J., and then slit into cover tapes with various different widths (for example, 5.4 mm, 9.3 mm, and 13.3 mm). Table 1 (below) reports physical properties of the cover tapes made according to Example 1.

TABLE 1

| | | | TABER |
|---|---|---|---|
| STATIC | | | ABRASION |
| CONTROL | | | RESISTANCE, |
| LAYER | LIGHT | SURFACE | number of |
| THICKNESS, | TRANSMITTANCE, | RESISTIVITY, | cycles |
| micron | percent | ohms/square | before failure |
| 0.2 | 89 | 1 × 10⁷ | >100 |

In addition, the static control layer was not removed when adhered to SCOTCH TRANSPARENT FILM TAPE 600 adhesive tape from 3M Company (Saint Paul, Minn.), followed by peeling off the tape at a 135 peel angle generally according to ASTM D1000-10 “Standard Test Methods for Pressure-Sensitive Adhesive-Coated Tapes Used for Electrical and Electronic Applications” using a sample width of one inch (2.5 cm), and a peel speed of 300 mm/min.

Various modifications and alterations of this disclosure may be made by those skilled in the art without departing from the scope and spirit of this disclosure, and it should be understood that this disclosure is not to be unduly limited to the illustrative embodiments set forth herein.

What is claimed is:

1. A cover tape comprising:
a polymer film substrate having first and second opposed major surfaces;
a primer layer disposed on the first major surface of the polymer film substrate;
a static control layer disposed on the primer layer, the static control layer comprising carbon nanotubes dispersed in a dielectric polymeric binder, wherein the static control layer has a thickness of from 0.1 to 2 microns; and
adhesive strips disposed on the static control layer adjacent opposite edges of the static control layer, wherein the adhesive strips comprise a heat-activated adhesive.

2. The cover tape of claim 1, wherein the dielectric polymeric binder comprises at least one of a polyurethane or an acrylic polymer.

3. The cover tape of claim 1, wherein the carbon nanotubes are present in the static control layer in an amount of from 1 to 3 percent by weight based on a total weight of the static control layer.

4. The cover tape of claim 1, wherein the static control layer has a thickness in a range of from 0.1 to 0.5 microns.

5. The cover tape of claim 1, wherein the polymer film substrate comprises biaxially-oriented polypropylene.

6. The cover tape of claim 1, wherein the first major surface of the polymer film substrate is corona-treated.

7. A component package comprising:
a carrier tape comprising a film body having at least one pocket recess therein;
at least one electronic component disposed within the at least one pocket recess; and
a cover tape releasably adhered to the carrier tape such that the at least one pocket recess is substantially sealed, wherein the cover tape comprises:
a polymer film substrate having first and second opposed major surfaces;
a primer layer disposed on the first major surface of the polymer film substrate;
a static control layer disposed on the primer layer, the static control layer comprising carbon nanotubes dispersed in a dielectric polymeric binder, wherein the static control layer has a thickness of from 0.1 to 2 microns; and
adhesive strips disposed on the static control layer adjacent opposite edges of the static control layer, wherein the adhesive strips comprise a heat-activated adhesive, and wherein the adhesive strips contact the carrier tape.

8. The component package of claim 7, wherein the dielectric polymeric binder comprises at least one of a polyurethane or an acrylic polymer.

9. The component package of claim 7, wherein the carbon nanotubes are present in the static control layer in an amount of from 1 to 3 percent by weight based on a total weight of the static control layer.

10. The component package of claim 7, wherein the static control layer has a thickness in a range of from 0.1 to 0.5 microns.

11. The component package of claim 7, wherein the polymer film substrate comprises biaxially-oriented polypropylene.

12. The component package of claim 7, wherein the first major surface of the polymer film substrate is corona-treated.

13. A method of making a cover tape, the method comprising:
providing a polymer film substrate having first and second opposed major surfaces;
applying a primer layer onto the first major surface of the polymer film substrate;
applying a static control layer onto the primer layer, the static control layer comprising carbon nanotubes dispersed in a dielectric polymeric binder, wherein the static control layer has a thickness of from 0.1 to 2 microns; and
disposing adhesive strips on the static control layer adjacent opposite edges of the static control layer.

14. The method of claim 13, wherein the dielectric polymeric binder comprises at least one of a polyurethane or an acrylic polymer.

15. The method of claim 13, wherein the carbon nanotubes are present in the static control layer in an amount of from 1 to 3 percent by weight based on a total weight of the static control layer.

16. The method of claim 13, wherein the static control layer has a thickness in a range of from 0.1 to 0.5 microns.

17. The method of claim 13, wherein the polymer film substrate comprises biaxially-oriented polypropylene.

18. The method of claim 13, further comprising corona treating the first major surface of the polymer film substrate.
